(19) United States
(12) Patent Application Publication
(10) Pub. No.: US 2014/0185624 A1
(43) Pub. Date: Jul. 3, 2014

(54) METHOD FOR REACTIONLESS REDUNDANT COUPLING OF COMMUNICATION NETWORKS BY MEANS OF THE RAPID SPANNING TREE PROTOCOL

(71) Applicants: Henri Mueller, Spaichingen (DE); George Ditzel, Nashua, NH (US); Oliver Kleineberg, Wendlingen (DE); Alen Mehmedagic, Wilmington, MA (US); Dirk Mohl, Esslingen (DE); Zbigniew Pelzer, Neckartailfingen (DE); Markus Renz, Gomaringen (DE); Markus Seehofer, Rechberghausen (DE); Vijay Vallala, North Andover, MA (US)

(72) Inventors: Henri Mueller, Spaichingen (DE); George Ditzel, Nashua, NH (US); Oliver Kleineberg, Wendlingen (DE); Alen Mehmedagic, Wilmington, MA (US); Dirk Mohl, Esslingen (DE); Zbigniew Pelzer, Neckartailfingen (DE); Markus Renz, Gomaringen (DE); Markus Seehofer, Rechberghausen (DE); Vijay Vallala, North Andover, MA (US)

(21) Appl. No.: 14/113,113

(22) PCT Filed: Jun. 20, 2012
(86) PCT No.: PCT/EP2012/002608

§ 371 Date: Feb. 10, 2014

(30) Foreign Application Priority Data
Jun. 20, 2011 (DE) 10 2011 105 390.9

(51) Int. Cl. H04L 29/08

(52) U.S. Cl. CPC H04L 67/10
USPC 370/401

(57) ABSTRACT

The invention relates to a method for redundantly and reactionlessly connecting networks to each other, such as communication networks, particularly Ethernet networks, wherein there is a plurality of network devices which communicate and exchange data with each other via data lines in the network which has at least one, preferably a plurality of network segments, characterized in that at least more than one RSTP protocol instance is implemented on the network devices for coupling network segments so that one network segment can be connected per RSTP protocol instance.

The invention relates to a method of redundant and feedback-free interconnection of networks, such as communication networks, particularly Ethernet networks, where at least one network having preferably multiple network segments also has multiple network devices that communicate with each other via data lines and exchange data according to the features of the preamble of claim 1.

Prior-art systems are known and exist that allow the use of redundant media connections in an Ethernet network. Due to the broadcast characteristic of Ethernet, only one active path from the communications source to the communications sink is permitted. Additional paths and the thus inserted loops inserted in the is network structure inevitably result in the Ethernet frames continuously circulating and paralyzing all the network traffic due to overloading.

To nevertheless permit redundant connections for error backup purposes, a plurality of protocols were proposed that can turn off redundant paths for the active communication and activate them only when needed. The rapid spanning tree protocol (RSTP) defined in Standard IEEE 802.1D-2004 and the media redundancy protocol (MRP) defined in Standard IEC 62439-2 are examples.

The RSTP can hereby cover any network topologies by expanding its effective range to all network devices in all networks or network segments to be coupled, and can thereby recognize all existing loops. Thus, according to IEEE 802.1D-2004, one single protocol instance operates on each network device, and all distributed protocol instances are assigned to a shared logic RSTP net.

Conversely however, this also means that in the event of a reconfiguration of the active network paths (connections between the network devices via the data lines), for example after a malfunction (for example cable break or comparable) of a physical active connection, all interconnected network segments are affected by this reconfiguration, even if the error occurs only in one network segment and the other network segments were not affected. This has an adverse effect on the performance of the entire network.

The enhancement of the RSTP, the multiple spanning tree protocol (MSTP described in IEEE 802.1Q-2005) also works exactly like the RSTP with a shared MSTP network distributed over all participating network devices, the common internal spanning tree (CIST) instance. In addition, exactly one MSTP protocol instance operates on each network device.

The MSTP does allow the allocation of network segments in regions that work with network devices outside the region like a single RSTP/MSTP device. The MSTP regions are however not entirely feedback-free between each other; the failure of the so-called root bridge of the CIST can have an effect on all MSTP regions and their connections to each other.

Therefore, the object of the invention is to limit the effects of a reconfiguration to that particular network segment in which an occurred error actually makes this necessary.

The present invention thus describes a method of redundant and feedback-free interconnection of networks, such as communications networks and particularly Ethernet networks, for increasing their performance.

The solution according to the invention is a method of using the rapid spanning tree protocol to redundantly couple network segments to each other and simultaneously ensure that the coupled network segments function relative to each other in a feedback-free manner.

To this end, more than one protocol instance is used by the RSTP on network devices for coupling network segments. Therefore, one network segment can be connected per RSTP protocol instance.

This is a significant advantageous step for constructing modern, high-availability networks, preferably Ethernet networks, in a scalable and flexible manner, without the disadvantages of feedback from individual redundant segments to each other making these coupled networks unusable for practical implementation. In addition, the performance of the network is significantly improved, since reconfigurations can be executed very quickly.

A typical case is the implementation of exactly two RSTP protocol instances in a network device that allows the coupling of two networks or network segments to each other. However, the method is not limited to two such instances, but can be also applied to more than two instances.

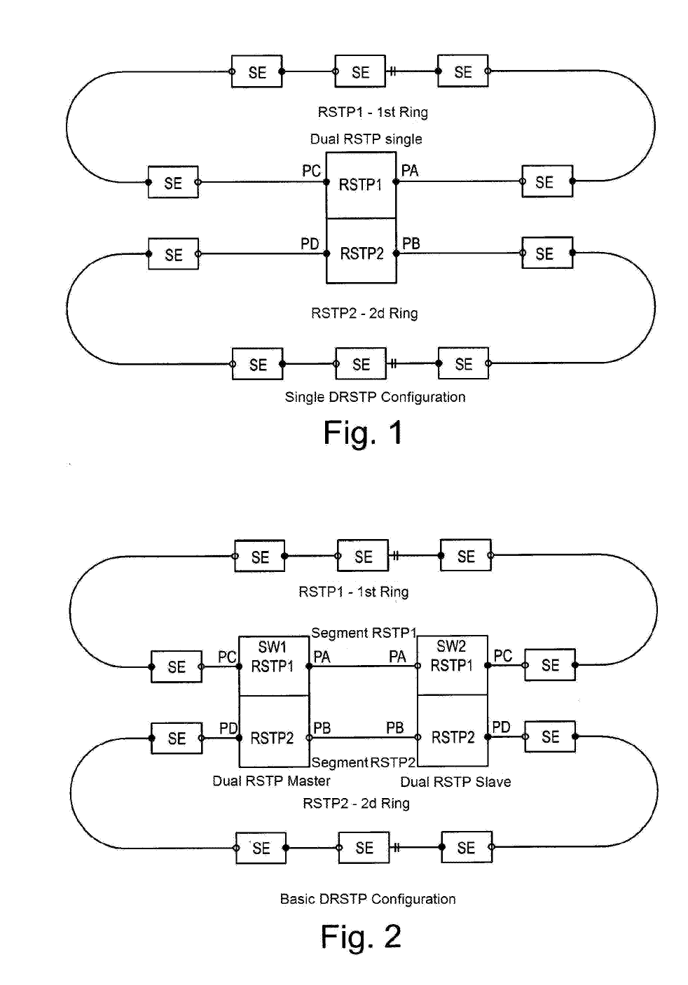

In FIG. 1, such a setup is schematically shown for two network or network segments to be coupled by a dual RSTP device, the here so-called coupling element. The dual RSTP single device hereby acts as a coupling element between the two network segments (RSTP1-primary ring and RSTP2-secondary ring). The two coupled networks are for example hereby configured as ring networks; however, the method is not restricted to it. RSTP1-primary ring and RSTP2-secondary ring however can also be two self-contained networks acting independently of each other. In addition, more than two RSTP“n”-segments (“n”>2) can be present and be coupled to each other by one additional coupling element in each case.

Each of the RSTP protocol instances implemented on the coupling network device Dual RSTP Single (coupling element) are each assigned network connections with which the coupling device (=coupling element) is connected into the respective network segment.

In FIG. 1, according to protocol instance RSTP1, the network connections are assigned to network RSTP1-primary ring and according to protocol instance RSTP2, the network connections are assigned to network RSTP2-secondary ring.

Now if an error occurs in the RSTP1-primary ring and if this error causes a reconfiguration of the network, this reconfiguration will have an effect only within the RSTP1 network. Also within the coupling element dual RSTP single, only protocol instance RSTP1 is affected. This ensures that both RSTP networks are coupled in a feedback-free manner.

Another challenge that is solved by the invention is the redundant coupling of two or more networks by the described method. In FIG. 1, the coupling element dual RSTP single itself represents one single error element that on failure interrupts all communication between the two network segments. Due to this fact, the coupling device can also be configured redundantly, as schematically shown in FIG. 2.

However, it should be noted here that due to the redundant coupling of both network segments RSTP1-primary ring and RSTP2-secondary ring, a network loop is created. This network loop cannot be resolved by RSTP itself, since due to the required feedback-free property, the RSTP instances RSTP1 and RSTP2 on the is respective two coupling units dual RSTP master and dual RSTP slave are not coupled to each other, and thus cannot recognize the network loop.

To prevent frames from recirculating through the network loop, an additional system component in the master and slave coupling elements ensures that only one of the two devices always transmits frames between the two network segments. The coupling devices exchange between each other control messages regarding the two network segments RSTP1-primary ring and RSTP2-secondary ring to monitor the status of the respective other coupling element. One of the devices assumes the status of the coupling master, while all the other devices assume the status of coupling slaves. Only the coupling master transmits frames between the network segments, the coupling slaves block transmission between the RSTP protocol instances. The statuses of master and slave can here be accepted by the coupling devices both by manual configuration as well as by an automatic selection mechanism.

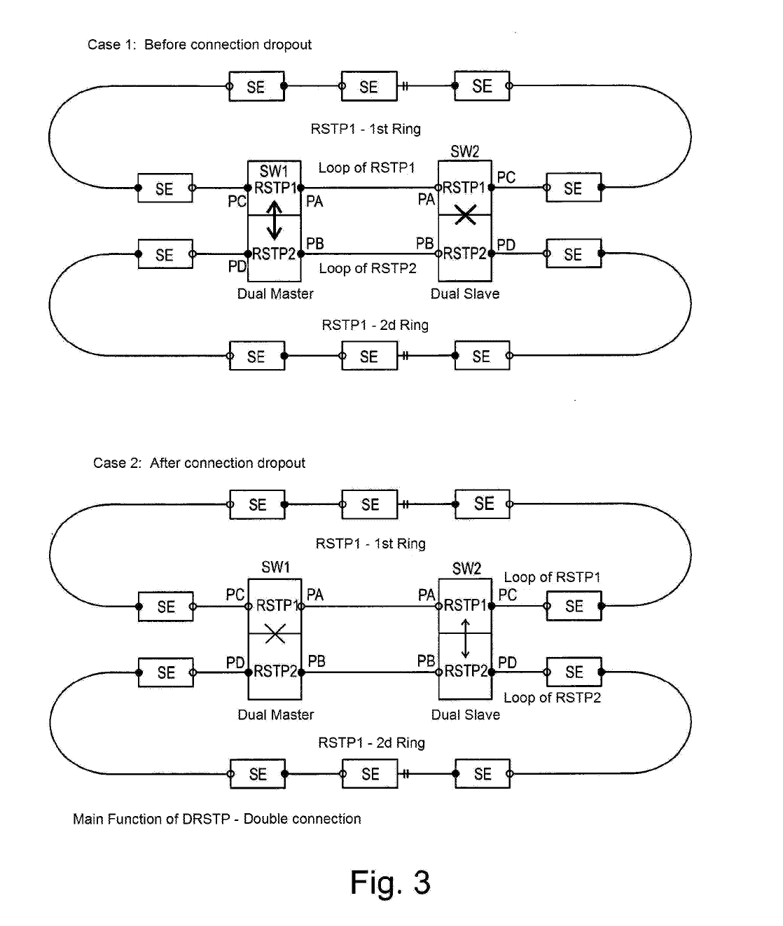

A slave must begin with the transmission of frames between the network segments when the connection between the two network segments is no longer assured by the master. This is shown by way of example in FIG. 3. In FIG. 3, Case 1, device SW1 is in master status and SW2 is in slave status. Accordingly, SW1 transmits between the segments (indicated by a double arrow), while SW2 has its connection between the RSTP instances interrupted (indicated by the cross) to prevent recirculation of frames.

In FIG. 3, Case 2, the device SW1 has lost both connections (PC and PA) in network RSTP1-primary ring due to is several defects. Therefore, the device SW2 must activate the connection between its RSTP instances to continue safeguarding the connection of both network segments. SW2 obtains this information from SW1 via the still functioning connection between SW1 and SW2 via the second network segment RSTP2-secondary ring.

If device SW1 were to fail completely, then device SW2 recognizes, through the complete communications failure with device SW1, that it must activate the connection itself between its RSTP instances.

1. A method of redundant and feedback-free interconnection of networks such as communication networks, in particular Ethernet networks, wherein at least one network having preferably multiple network segments also has multiple network devices that communicate and exchange data with each other via data lines, wherein more than one RSTP protocol instance is implemented on the network devices for the coupling of network segments so that each network segment instance is connectable via its own respective RSTP protocol.

2. The method according to claim 1, wherein each of the RSTP protocol instances implemented on the coupling network device dual RSTP single have allocated the network connections with which the coupling device is connected into the respective network segment.

3. The method according to claim 1, wherein, when an error occurs in a network segment and causes a reconfiguration of the network, this reconfiguration has an effect only within this network segment, wherein within the coupling element only this protocol instance is also affected.

4. The method according to claim 1, wherein to prevent the recirculation of frames through a network loop, an additional system component in the master and slave coupling elements ensures that only one of the two frames devices is transmitted between the two network segments, for which the coupling devices exchange control messages about the two network segments RSTP1-primary ring and RSTP2-secondary ring to monitor the status of the respective other coupling element.

5. The method according to claim 4, wherein the statuses of the master or slave can be accepted by the coupling devices by manual configuration or by an automatic selection mechanism.

6. The method according to claim 4, wherein a slave must begin with the transmission of frames between the network segments when the connection between the two network segments is not assured by the master.

7. The method according to claim 1, wherein the two coupled networks are operated as ring networks.
